(19) United States
(12) Patent Application Publication
(10) Pub. No.: US 2025/0322440 A1
(43) Pub. Date: Oct. 16, 2025

(54) VARIABLE PROCESSING WITH MACHINE LEARNING USAGE PREDICTION

(71) Applicant: INTUIT INC., Mountain View, CA (US)

(72) Inventors: Sangeetha Uthamalingam SANTHARAM, Mountain View, CA (US); Debdulal DEY, Mountain View, CA (US); Elizabeth BERGER, Mountain View, CA (US); Jaiswin Bhaskaram SUNDARARAJAN, Mountain View, CA (US); Farzaneh KHOSHNEVISAN, Mountain View, CA (US); Sonia SHARMA, Mountain View, CA (US); Byungkyu KANG, Mountain View, CA (US); Kate Elizabeth SWIFT-SPONG, Mountain View, CA (US)

(73) Assignee: INTUIT INC., Mountain View, CA (US)

(21) Appl. No.: 18/633,382

(22) Filed: Apr. 11, 2024

(51) Int. Cl. G06Q 30/0601

(52) U.S. Cl. CPC G06Q 30/0621; G06Q 30/0641

(57) ABSTRACT

At least one processor may receive user data indicating a scope of work and predicting at least one resource required to complete the scope of work. The predicting may include processing the user data with a machine learning (ML) process. The at least one processor may determine at least one provisioning property of the at least one resource and apply the at least one provisioning property to a standard product offering, thereby creating a customized product offering commensurate with the scope of work. The at least one processor may perform processing responsive to a user request using the customized product offering.

### BACKGROUND

In many cases products and/or services are offered to users under a “one size fits all” approach. That is, the product and/or service is configured to meet the needs of a variety of different users. However, many users may not use all features of the product and/or service. On the other hand, some users may have unusual demands that differ from the default expectations. As a result, technical provisioning of the product and/or service, and even staffing and/or pricing in some cases, becomes inefficient and out of alignment with eventual use.

### BRIEF DESCRIPTIONS OF THE DRAWINGS

FIG. 1 shows an example customization process according to some embodiments of the disclosure.

FIG. 2 shows an example prediction and provisioning system according to some embodiments of the disclosure.

FIG. 3A shows an example prediction and provisioning process according to some embodiments of the disclosure.

FIG. 3B shows an example prediction and provisioning process according to some embodiments of the disclosure.

FIG. 4 shows an example pricing table according to some embodiments of the disclosure.

FIG. 5 shows an example code mapping table according to some embodiments of the disclosure.

FIG. 6 shows an example machine learning training and deployment process according to some embodiments of the disclosure.

FIG. 7 shows an example computing device according to some embodiments of the disclosure.

### DETAILED DESCRIPTION OF SEVERAL EMBODIMENTS

Embodiments described herein may provide automated systems and methods that can predict a user's needs within a product and/or service and provision the product and/or service accordingly. For example, disclosed embodiments may use one or more machine learning (ML) techniques to predict resources that will be requested or employed by the user. Disclosed embodiments may determine how to provision such resources and create customized offerings for users that include the provisioned resources. For example, this can allow some embodiments to customize technical provisioning, staffing, and/or pricing even before a user starts working with the product and/or service, and in some embodiments, the customization may be updated as more data (e.g., user data) becomes available. As a result, products and/or services can be offered and deployed in a more efficient and more user-customized manner when compared with products and/or services that lack such prediction and provisioning features.

As a specific, non-limiting example, some embodiments may be used in connection with tax preparation software. Historically, tax pricing software has been offered with standard pricing that is charged to all users and standard features that are given to all users. In some cases, users can select tiers of different price and service levels, but even so, the levels themselves are standardized in terms of price and features. Accordingly, in many cases users may be forced to pay more money for more features than they need. In other cases, users may select products lacking features they did not realize they needed and/or may be charged insufficiently for the features utilized. To address these issues, some embodiments described herein can provide a customized product with customized features and even a customized pricing quote to customers before the tax preparation starts. The customization can be based on customer data and the tax forms the customers need. The customization can be updated as tax preparation progresses and finalized once the tax preparation is complete.

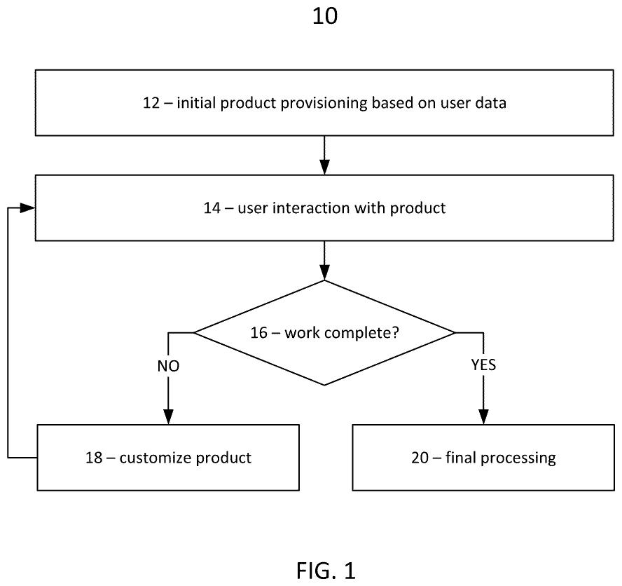

FIG. 1 shows an example customization process 10 according to some embodiments of the disclosure. Process 10 is presented as a high-level example of customization to illustrate basic concepts discussed throughout the present disclosure. Specific embodiments of systems and methods that can customize products follow the example of FIG. 1.

At 12, a product may be initially provisioned. This can be a default provisioning or can be based at least in part on custom data such as user data. For example, a user can log into a tax preparation software platform and see a user interface (UI) that is either a default UI or a UI that is customized at least somewhat according to user data (e.g., greeting including the user's name, one or more options presented that relate to previously-collected user data, etc.).

At 14, the user can interact with the product. The interaction can update the data available to the product. For example, the user can enter information into UI fields, make selections from UI menus, etc. At 16, after the user interaction, it may be determined whether work is complete. For example, the user may request for taxes to be filed, or another task to be finalized, depending on the particular use case.

At 18, if work is not yet complete, the product may be customized based at least in part on data received and/or generated during the user interaction. For example, as described in detail below, the disclosed systems and methods may employ ML techniques to predict future user requests or needs and provision the product accordingly. Following the updated product customization, further user interactions and customizations may occur in a feedback loop style process that continuously provides relevant information and/or options to the user. Once work is complete, at 20, final processing may be performed.

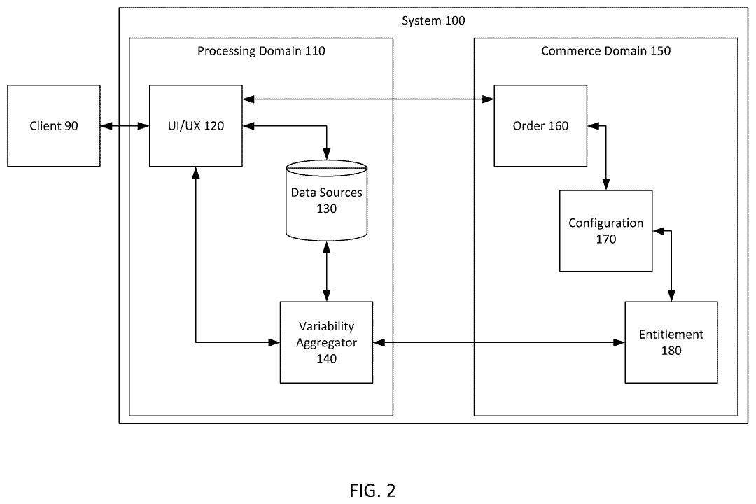

FIG. 2 shows an example prediction and provisioning system 100 according to some embodiments of the disclosure. System 100 may include processing domain 110 and/or commerce domain 150. Processing domain 110 may include user interface/user experience (UI/UX) module 120, one or multiple data sources 130, and/or variability aggregator module 140, the features and functions of which are described in detail below. Processing domain 110 may be customized for a particular processing type in some embodiments. For example, in cases where system 100 is used for tax processing, processing domain 110 may serve as a “tax domain” that may gather and/or process tax-related data. Commerce domain 150 may include order module 160, configuration module 170, and/or entitlement module 180, the features and functions of which are described in detail below. In some embodiments, system 100 may include additional modules (not shown) that are commonly included in customer service platforms and/or other modules. As described in detail below, system 100 may interact with client 90 to predict product requirements, customize the product, and/or facilitate client 90 interaction with the product.

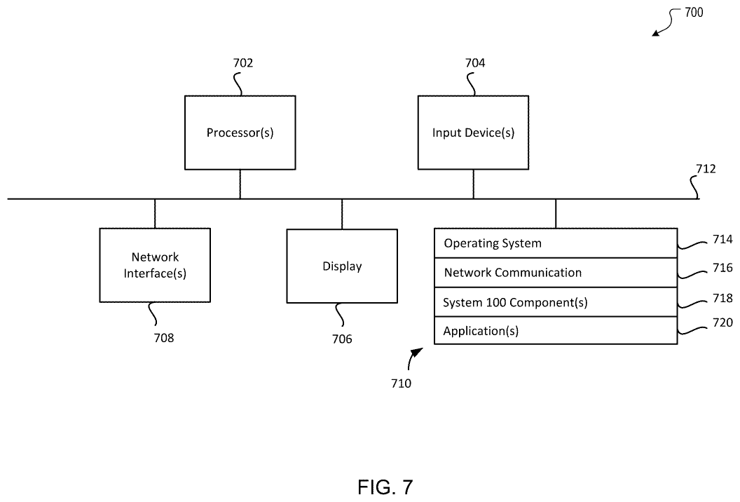

Illustrated components may include a variety of hardware, firmware, and/or software components that interact with one another. Some components shown in FIG. 2 may communicate with one another using networks. For example, client 90 may access system 100 (e.g., UI/UX module 120) through one or more networks (e.g., the Internet, an intranet, and/or one or more networks that provide a cloud environment). In another example, UI/UX module 120 and/or variability aggregator 140 may use the one or more networks to add data to and/or obtain data from one or more external data sources 130. In another example, processing domain 110 and commerce domain 150 may use the one or more networks to communicate with one another. Each component may be implemented by one or more computers (e.g., as described below with respect to FIG. 7).

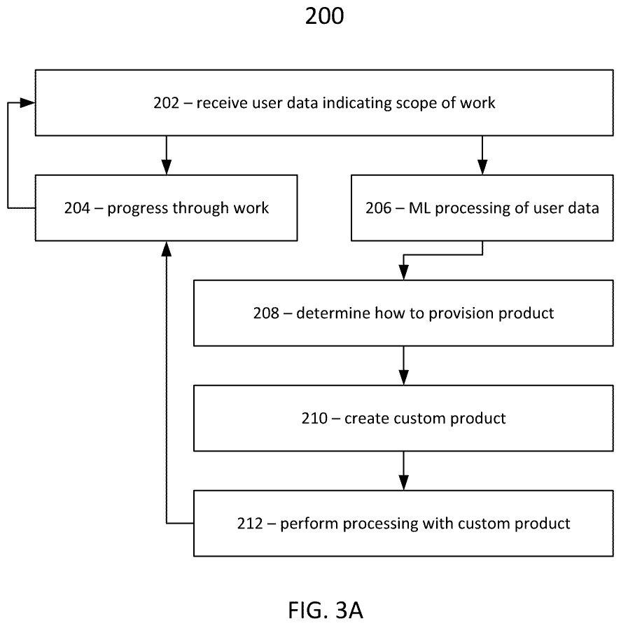

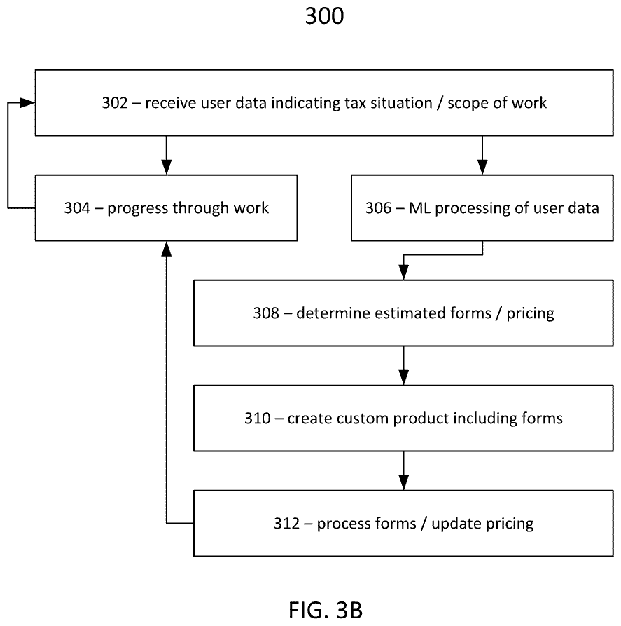

The elements of system 100 are described in greater detail below with respect to FIGS. 3A-6. but in general, processing domain 110 may gather data and predict product requirements, and commerce domain 150 may provision and deliver products. For example, as described in detail herein, UI/UX module 120 may gather data from client 90 and store the data in data sources 130. Variability aggregator module 140 may use the data to predict product characteristics that may be useful to the user of client 90. Entitlement module 180 may use predictions to pre-select features of the product, while order module 160 may gather updates to actual use from UI/UX 120.

Configuration module 170 may use data from order module 160 and entitlement module 180 to configure the product, which may be provided to UI/UX module 120 from order module 160, allowing client 90 to access the configured product.

Elements illustrated in FIG. 2 (e.g., system 100 (including processing domain 110 and its modules (UI/UX module 120, data source 130, and variability aggregator module 140) and processing domain 120 and its modules (order module 160, configuration module 170, and entitlement module 180) and client 90) are each depicted as single blocks for ease of illustration, but those of ordinary skill in the art will appreciate that these may be embodied in different forms for different implementations. For example, while separate modules of system 100 are depicted separately, any combination of these elements may be part of a combined hardware, firmware, and/or software element. Moreover, while the modules are depicted as parts of a single system 100 element, any combination of these elements may be distributed among multiple logical and/or physical locations. Also, while one client 90, one system 100 with one processing domain 110 and one commerce domain 150, and one of each module (e.g., UI/UX module 120, data source 130, variability aggregator module 140, order module 150, configuration module 160, and entitlement module 180) are illustrated, this is for clarity only, and multiples of any of the above elements may be present. In practice, there may be single instances or multiples of any of the illustrated elements, and/or these elements may be combined or co-located. For example, system 100 may interact with multiple clients 10 and may employ multiple data sources 130.

In the following descriptions of how the illustrated components function, several examples are presented, including examples using specific data or data types. However, those of ordinary skill in the art will appreciate that these examples are merely for illustration, and the disclosed embodiments are extendable to other application and data contexts.

FIG. 3A shows an example prediction and provisioning process 200 according to some embodiments of the disclosure. System 100 may perform process 200 to predict resources to be used for a given task and provision a product with the predicted resources, for example. Process 200 is an example of a general case, with specific examples and subsets of process 200 detailed in subsequent figures.

At 202, system 100 may receive user data indicating a scope of work. For example, a user may access a UI through client 90. The UI may be generated locally by client 90, by system 100 (e.g., by UI/UX module 120), by one or more third-party devices, and/or a combination thereof. In any event, the UI may gather user data, for example by receiving data entered by a user into one or more fields, data from one or more files uploaded by the user, data from third-party or external sources identified by the user, data from data source 130 identified by the user and/or automatically identified by system 100, and/or other sources.

The data received at 202 may indicate a scope of work in one or more ways. For example, the data may indicate a request for a task to be performed, such as a tax filing (as described in a detailed example below) or other automated computing task. The data may further include some or all information that is to be used in completing the task, such as data describing the user, data describing specific requirements of the task, and/or data required to complete the task (e.g., in the tax example, user personal data needed to fill out a tax form and/or identification of tax jurisdictions may be the types of data collected by system 100).

In some embodiments, system 100 may collect the user data indicating the scope of work at the beginning of process 200. In other embodiments, system 100 may update the user data indicating the scope of work over time. In such cases, at 204, system 100 may progress through the requested work and, periodically and/or as required or prompted, may return to 202 to collect more data. For example, the work may require some initial information to get started and may begin once the user has provided the initial information. The user may continue to interact with the UI after work has begun, supplying more user data that indicates the scope of work. Completion of one step in a work flow may reveal that additional data is needed, the UI may prompt the user for the additional data, and the user may supply the additional data. Accordingly, the UI may include a progression of interface elements and, as the UI progresses through the interface elements, system 100 may receive and update the user data through the UI.

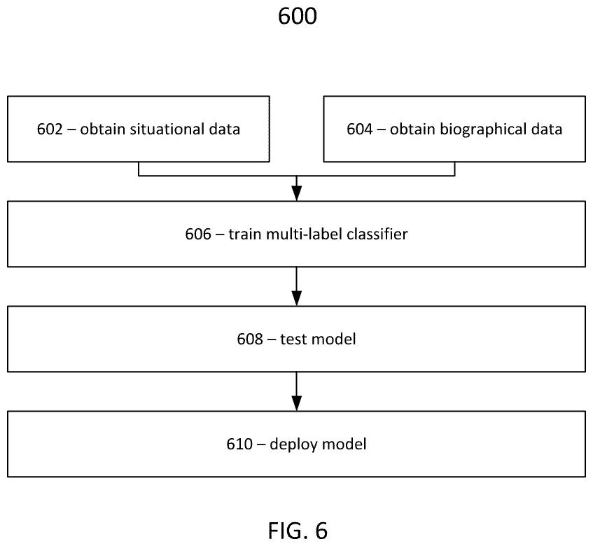

At 206, system 100 may perform ML processing using the user data received at 202 as input. For example, variability aggregator module 140 can perform ML processing that can include predicting at least one resource required to complete the scope of work through processing the user data with an ML process using one or more ML models. Taking the at least one resource as input, the ML process can determine an estimated product offering as its output. Variability aggregator module 140 can provide the estimated product offering and/or information describing the estimated product offering to UI/UX module 120. UI/UX module 120 can provide information describing the estimated product offering to a user, for example through the UI presented to the user through client 20. Specific examples of ML models that may be used, how to train the ML models, and/or how to use the ML models are described in detail below with reference to FIG. 6.

At 208, based on the prediction at 206 and/or observed actual work progressing at 204, system 100 can determine how to provision the product to meet the user's needs, including determining at least one provisioning property of the at least one resource. In some cases, this may include accessing and/or referencing external information. For example, determining the provisioning property may include determining at least one resource code of the at least one resource, mapping the at least one resource code to at least one application programming interface (API) code, sending at least one API call including the at least one API code to at least one API, and receiving, from the at least one API in response to the sending, data indicating the at least one provisioning property. Provisioning properties may include technical properties of the product and/or extrinsic properties. For example, in some cases the at least one provisioning property can include at least one price. Some examples of determining are described in detail below with reference to FIGS. 3B-5.

At 210, system 100 can create a custom product provisioned as determined at 208. For example, one or more of the commerce domain 150 components can apply the at least one provisioning property to a standard product offering, thereby creating a customized product offering commensurate with the scope of work. The customized product offering can have one or more custom technical features. In cases where the at least one provisioning property includes at least one price, the customized product offering can include a product price incorporating the at least one price.

At 212, system 100, for example one or more of the commerce domain 150 components and/or other processing components (not shown), can perform processing responsive to a user request using the customized product offering. This processing can use the provisioned customized features as determined above. Moreover, to the extent that additional user data is gathered through the processing using the customized product offering, system 100 can repeat the predicting, determining, and applying at 206-210 in response to the updating of the user data.

FIG. 3B shows an example prediction and provisioning process 300 according to some embodiments of the disclosure. This example process 300 provides an example use case. In this example use case, the product being provisioned is a tax filing engine, and features that are customized can include, for example, forms and workflows used to prepare a tax filing and/or prices charged to the user for preparing and filing taxes. The following example demonstrates how the general process 200 described above can work in a real situation, but it should be understood that the systems and methods described herein are not only limited to the example process 300 of FIG. 3.

The illustrated example of FIG. 3B is motivated by an improvement to current technologies wherein with tax preparation systems, a customer's tax situation is unique per customer, but pricing models tend to be either fixed or tiered into a small number of fixed tiers. By performing process 300, system 100 can predict what resources will actually be used by the user to prepare the tax filing. Thus, system 100 can customize a tax software offering on an individual-user basis, generating a unique configuration of a tax prep software/service product instead of the previous standardized product offerings. This results in technically unique products that are optimized for the processing that actually needs to be done, and also allows for variable pricing, wherein personalized pricing is used to price the customer right based on their unique tax situation. A number of different variables like count of forms, the actual tax data, etc. may be used from customer data to determine product configuration and pricing.

At 302, system 100 may receive user data indicating a scope of work related to the user's tax situation. For example, a user may access a UI through client 90. The UI may be generated locally by client 90, by system 100 (e.g., by UI/UX module 120), by one or more third-party devices, and/or a combination thereof. In any event, the UI may gather user data, for example by receiving data entered by a user into one or more fields, data from one or more files uploaded by the user, data from third-party or external sources identified by the user, data from data source 130 identified by the user and/or automatically identified by system 100, and/or other sources. The data may include, but is not limited to, user-entered answers to tax-related questions presented in the UI, tax-related documents or forms uploaded by the user through the UI, tax-related documents or forms accessed by system 100 upon receipt of user permission through the UI, metadata related to any of the above, and/or other data.

In some embodiments, system 100 may collect the user data indicating the scope of work at the beginning of process 300. In other embodiments, system 100 may update the user data indicating the scope of work over time. In these cases, customers may provide data about their tax situation throughout the product experience as they interact with the UI. For example, UI/UX module 120 may receive the answer to one tax question and ask a follow-on question or a question on a new topic. In such cases, at 304, system 100 may progress through the requested work and, periodically and/or as required or prompted, may return to 302 to collect more data. For example, the tax preparation may require some initial information to get started, such as basic user identifying information and/or demographic information, and may begin once the user has provided the initial information. The user may continue to interact with the UI after work has begun, supplying more user data that indicates the scope of work related to the user's specific tax situation. Completion of one step in a work flow may reveal that additional data is needed, the UI may prompt the user for the additional data, and the user may supply the additional data. Accordingly, the UI may include a progression of interface elements and, as the UI progresses through the interface elements, system 100 may receive and update the user data through the UI.

At 306, system 100 may perform ML processing using the user data received at 304 as input. For example, variability aggregator module 140 can perform ML processing that can include predicting at least one resource required to complete the scope of work through processing the user data with an ML process using one or more ML models. Taking the at least one resource as input, the ML process can determine an estimated product offering as its output. Variability aggregator module 140 can provide the estimated product offering and/or information describing the estimated product offering to UI/UX module 120. UI/UX module 120 can provide information describing the estimated product offering to a user, for example through the UI presented to the user through client 20.

ML processing may include predicting the at least one resource using a multi-label classifier, which may be trained as described in detail below. For example, variability aggregator module 140 may predict one or more tax forms that may be required to complete the user's tax submission based on the input provided. The one or more ML models may be trained on tax submissions by the user in prior years and/or other users in the current year and/or prior years (i.e., multi-label classification). The training data may include completed and filed tax submissions, where given users' entire record of form usage and input data is available. Accordingly, variability aggregator module 140 may be able to predict a user's tax form needs based on tax forms used in previous situations where tax data input to system 100 was similar. An example of ML training that can prepare the one or more ML models is described in greater detail below with respect to FIG. 6.

The following brief example illustrates how variability aggregator module 140 can predict the one or more tax forms based on the input provided. A user can provide data such as the contents of one or more W-2 forms as well as biographical information such as marital status and dependent status. System 100 can process this data using the ML model(s) and thereby obtain a prediction that a user having the income and/or deduction information from the W-2 and the demographic information provided is likely to need a particular set of forms. The ML model(s) can make this prediction based on training data that may include actual forms used by actual past users having similar input information.

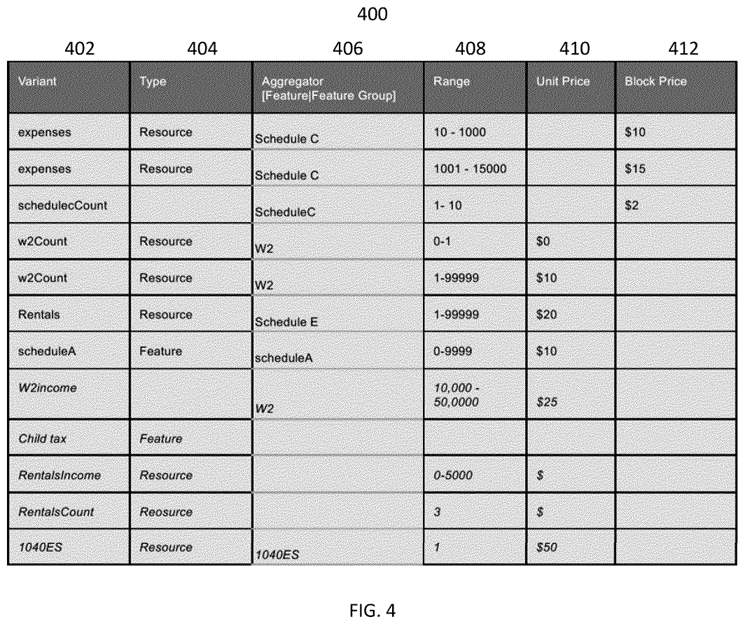

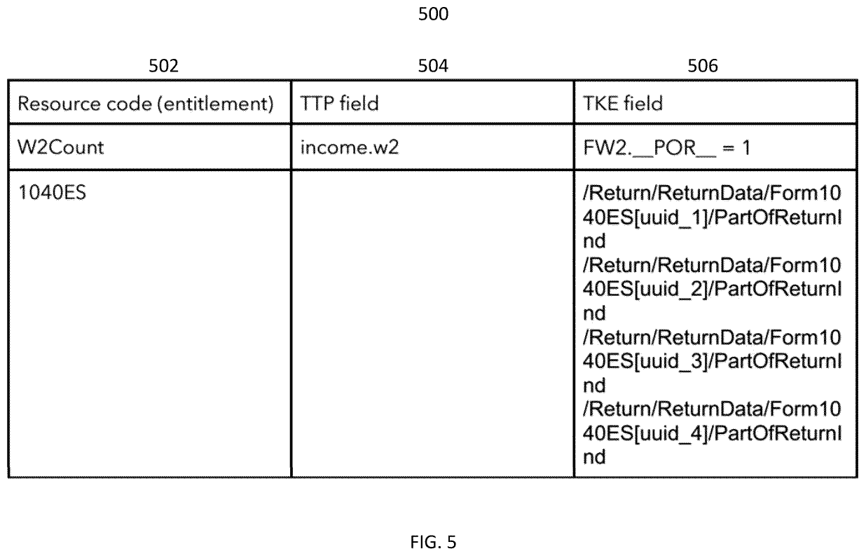

At 308, based on the prediction at 306 and/or observed actual work progressing at 304, system 100 can determine how to provision the product to meet the user's needs, including determining at least one provisioning property of the at least one resource. In this use case, the provisioning can include determining the tax forms likely to be required based on the prediction at 306 and/or determining pricing for a tax filing using the determined forms. In some cases, this may include accessing and/or referencing external information. For example, determining the provisioning property may include determining at least one resource code of the at least one resource, mapping the at least one resource code to at least one API code, sending at least one API call including the at least one API code to at least one API, and receiving, from the at least one API in response to the sending, data indicating the at least one provisioning property. For example, entitlement module 180 can obtain the specific forms using the API mapping(s) and API call(s). Example mappings and mapping techniques are described in detail below with respect to FIGS. 4 and 5.

At 310, system 100 can create a custom product provisioned as determined at 308. For example, one or more of the commerce domain 150 components can apply the at least one provisioning property to a standard product offering, thereby creating a customized product offering commensurate with the scope of work, which may include a tax preparation product with the identified forms included, and forms that have not been identified omitted. For example, entitlement module 180 can indicate what forms have been predicted and/or retrieved, and configuration module 170 can determine pricing and/or configuration for the indicated forms. In some embodiments, the customized product offering can include a product price corresponding to a sum of prices for each form included in the customized product offering.

At 312, system 100, for example one or more of the commerce domain 150 components and/or other processing components (not shown), can perform processing responsive to a user request using the customized product offering. For example, UI/UX module 120 may provide an indication of the predicted tax forms and/or predicted price to the user through the UI. Moreover, to the extent that additional user data is gathered through the processing using the customized product offering, system 100 can repeat the predicting, determining, and applying at 306-310 in response to the updating of the user data. Accordingly, UI/UX module 120 may provide an updated indication of the predicted tax forms and/or predicted price to the user through the UI as the data changes. Once the tax preparation is complete, UI/UX module 120 may show the actual pricing and/or actual forms used in the UI. The user can accept the completed product with the actual pricing and/or actual forms, and order module 160 can receive this acceptance and file the tax submission.

FIGS. 4 and 5 show examples of data that system 100 may use to create custom products in the tax preparation domain shown in FIG. 3B. These examples are meant to illustrate and to expand on the example process 300 of FIG. 3B. It should be understood that other types of products provisioned according to prediction and provisioning process 200 and/or similar processes may use different data.

FIG. 4 shows an example pricing table 400 according to some embodiments of the disclosure. One or more elements of system 100, for example configuration module 170, can use pricing table 400 or similar data arranged in a different format to determine pricing for a set of forms predicted by system 100 (e.g., by variability aggregator 140, as described above). For example, system 100 can use pricing table 400 to look up properties for provisioning a custom product, such as at 208 of process 200 or at 308 of process 300.

The example pricing table 400 arranges data type by column, as shown. The data types in the example include variant 402, type 404, aggregator 406, range 408, unit price 410, and block price 412. Variant 402, type 404, and/or aggregator 406 information can identify and/or distinguish between different form requirements. For example, “expenses” variant may indicate data of a “resource” type and may be a component of “Schedule C;” “w2Count” may indicate data of a “resource” type and may be a component of “W2;” etc. System 100 may positively identify forms required based on variant 402, type 404, and/or aggregator 406 information.

As an example of how system 100 can identify required forms based on variant 402, type 404, and/or aggregator 406 information, consider a UI configured to ask questions about a user's behavior in a tax period. For example, the UI may ask questions such as “Did you have a job last year?” or “Did you receive any dividends last year?” at 202 in process 200 or 302 in process 300. Based on the answer to the first question, system 100 may predict whether a W2 may be involved in the user's tax processing at 206 in process 200 or 306 in process 300. Based on the answer to the second question, system 100 may predict whether a 1099-DIV may be involved in the user's tax processing at 206 in process 200 or 306 in process 300. Other questions may be useful for predicting these features and/or other features in other embodiments or contexts.

In order to provide pricing for identified forms, system 100 may reference the remaining columns. For example, range 408 can indicate a quantity of a given form that is required (e.g., a number of expense reports involved in the tax preparation, or a number of W2 forms involved in the tax preparation, etc.). A unit price 410 and/or block price 412 may be associated with each range 408 for each form. As shown in the example table 400, an expense report count from 10-1000 may yield a block price of $10, and an expense report count from 1001-15000 may yield a block price of $15 (and expense report counts less than 10 may be free by virtue of being absent from table 400). In another example, a W2 count of 0-1 may yield a unit price of $0, and a W2 count greater than one may yield a unit price of $10 per W2 in excess of one.

Pricing table 400 is shown as an example of one mechanism by which system 100 can customize a product offering. Specifically, pricing table 400 is for customizing a price property of a tax filing product. It will be understood that system 100 may use other data, including other lookup data, in other forms and with other content for other products or scenarios.

FIG. 5 shows an example code (e.g., API) mapping table 500 according to some embodiments of the disclosure. One or more elements of system 100, for example entitlement module 180, can use mapping table 500 or similar data arranged in a different format to communicate with the API of one or more data sources. For example, system 100 can use mapping table 500 to obtain customization data for a custom product, such as at 208 of process 200 or at 308 of process 300.

As discussed above, system 100 can identify required product elements (e.g., forms) based on variant 402, type 404, and/or aggregator 406 information and/or on the basis of other information received through a UI and processed by one or more ML models. For any product element or form identified, system 100 may use a mapping such as that shown in mapping table 500 to generate one or more API calls. In mapping table 500, resources 502 are in a first column, form codes 504 are in a second column, and API mappings 506 are in a third column. System 100 may look up resource 502 and/or form code 504 and retrieve an associated API mapping 506. System 100 may use the API code in the API mapping 506 to communicate with an API. For example, to retrieve a W2 form as shown in FIG. 5, system 100 may send API calls specified in API mapping 506 to a data source storing the forms. Then, system 100 may build the customized product that includes the requested element, in this case a W2 form.

FIG. 6 shows an example machine learning training and deployment process 600 according to some embodiments of the disclosure. In order to identify product components, such as tax preparation offering forms and/or prices, system 100 may train one or more ML models. Using the tax preparation example, the product components may be identifiable based on factors such as a customer reported tax scenario, forms that customers finally filed from a similar cohort of customers who reported a similar tax scenario, and/or possible input forms and output form combinations. In order to predict forms from customer reported tax scenarios, variability aggregator module 150 may deploy an ML model to predict the tax forms that a customer will have based on their prior year return filing, similar cohort of customers, and the current year tax scenario. Process 600 is an example of how system 100 may train at least one ML model used in the ML process with at least a first training data set indicative of example scopes of work and a second training data set indicative of example resources.

At 602, system 100 can obtain situational data to serve as a portion of ML training data. In some embodiments, the situational data can be verified and/or labeled manually or automatically. In the tax preparation example, situational data can include past tax submissions. For example, system 100 may obtain tax return data from previous product users and/or other sources for prior years and use numerical values of different line-items in the tax return, as well as the information about the number of certain forms in tax return and filing date, as situational data for ML training.

At 604, system 100 can obtain biographical data to serve as a portion of ML training data. In some embodiments, the biographical data can be verified and/or labeled manually or automatically. In the tax preparation example, biographical data can include life event and tax situation features (e.g., owns home, owns cryptocurrency, marital status, etc.). For example, system 100 may obtain biographical data from previous product users and/or other sources for prior years and use binary values for each variable as biographical data for ML training.

In the tax preparation example, the target prediction classes for the ML model may include documents that a user needs to upload. For training purposes, system 100 may use the historical data to infer the type of uploaded documents either based on the classified category of the document and/or tax form-based rules (e.g., if a certain line-item in the e-filed tax return is populated, then a certain document must have been uploaded).

At 606, system 100 can train a multi-label classifier ML model using the data obtained at 602 and 604. For example, with the above input features and list of uploaded documents as the target variable, system 100 may train an XGBoostClassifier or other model as a multi-label classifier.

At 608, system 100 can test the trained ML model. For example, to evaluate this model, system 100 may use Precision, Recall, F1 with Macro average across documents. System 100 may assess the performance at the engagement level (e.g., during runtime of process 200 and/or process 300) by comparing the number of predicted documents per engagement vs. the actual number of documents used by a user in the engagement.

At 610, system 100 may deploy the trained ML model (e.g., within process 200 and/or process 300 as described above). In the tax preparation example, at inference time, based on a user's data and prior year data, the trained model may predict whether each of the documents must be present, and that prediction may be used as the model output. Once trained, the ML model may be able to correctly predict and identify the customer usage of tax forms (both input and output tax forms), dynamically price products based on customers' tax forms and data in tax forms, and provide an estimated quote based on customer tax scenario. This data may be refined as the user completes a tax preparation, and at the end, system 100 may provide an actual price based on the customer tax scenario.

FIG. 7 shows a computing device 700 according to some embodiments of the disclosure. For example, computing device 700 may function as system 100 and/or any portion(s) thereof, or multiple computing devices 700 may function as system 100 and/or any portion(s) thereof.

Computing device 700 may be implemented on any electronic device that runs software applications derived from compiled instructions, including without limitation personal computers, servers, smart phones, media players, electronic tablets, game consoles, email devices, etc. In some implementations, computing device 700 may include one or more processors 702, one or more input devices 704, one or more display devices 706, one or more network interfaces 708, and one or more computer-readable mediums 710. Each of these components may be coupled by bus 712, and in some embodiments, these components may be distributed among multiple physical locations and coupled by a network.

Display device 706 may be any known display technology, including but not limited to display devices using Liquid Crystal Display (LCD) or Light Emitting Diode (LED) technology. Processor(s) 702 may use any known processor technology, including but not limited to graphics processors and multi-core processors. Input device 704 may be any known input device technology, including but not limited to a keyboard (including a virtual keyboard), mouse, track ball, and touch-sensitive pad or display. Bus 712 may be any known internal or external bus technology, including but not limited to ISA, EISA, PCI, PCI Express, NuBus, USB, Serial ATA or FireWire. In some embodiments, some or all devices shown as coupled by bus 712 may not be coupled to one another by a physical bus, but by a network connection, for example. Computer-readable medium 710 may be any medium that participates in providing instructions to processor(s) 702 for execution, including without limitation, non-volatile storage media (e.g., optical disks, magnetic disks, flash drives, etc.), or volatile media (e.g., SDRAM, ROM, etc.).

Computer-readable medium 710 may include various instructions 714 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 704; sending output to display device 706; keeping track of files and directories on computer-readable medium 710; controlling peripheral devices (e.g., disk drives, printers, etc.) which can be controlled directly or through an I/O controller; and managing traffic on bus 712. Network communications instructions 716 may establish and maintain network connections (e.g., software for implementing communication protocols, such as TCP/IP, HTTP, Ethernet, telephony, etc.).

System 100 components 718 may include instructions for performing the processing described herein. For example, system 100 components 718 may provide instructions for performing any and/or all of processes 200, 300, and/or 600, and/or other processing as described above. Application(s) 720 may be an application that uses or implements the outcome of processes described herein and/or other processes. In some embodiments, the various processes may also be implemented in operating system 714.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. A method comprising:
receiving, by at least one processor, user data indicating a scope of work;
predicting, by the at least one processor, at least one resource required to complete the scope of work, the predicting comprising processing the user data with a machine learning (ML) process;
determining, by the at least one processor, at least one provisioning property of the at least one resource;
applying, by the at least one processor, the at least one provisioning property to a standard product offering, thereby creating a customized product offering commensurate with the scope of work; and
performing, by the at least one processor, processing responsive to a user request using the customized product offering.

2. The method of claim 1, wherein the receiving comprises:
presenting a user interface (UI) comprising a progression of interface elements to the user; and
as the UI progresses through the interface elements, receiving and updating the user data through the UI.

3. The method of claim 2, further comprising repeating the predicting, determining, and applying in response to the updating of the user data.

4. The method of claim 1, wherein the determining comprises:
determining at least one resource code of the at least one resource;
mapping the at least one resource code to at least one application programming interface (API) code;
sending at least one API call including the at least one API code to at least one API; and
receiving, from the at least one API in response to the sending, data indicating the at least one provisioning property.

5. The method of claim 1, further comprising:
determining, by the at least one processor, an estimated product offering from the at least one resource; and
providing, by the at least one processor, information describing the estimated product offering to a user.

6. The method of claim 1, wherein the ML process comprises predicting the at least one resource using a multi-label classifier.

7. The method of claim 1, further comprising training, by the at least one processor, at least one ML model used in the ML process with at least a first training data set indicative of example scopes of work and a second training data set indicative of example resources.

8. The method of claim 1, wherein the at least one provisioning property includes at least one price, and the customized product offering includes a product price incorporating the at least one price.

9. A system comprising:
at least one processor; and
at least one non-transitory computer readable medium storing instructions that, when executed by the at least one processor, cause the at least one processor to perform processing comprising:
receiving user data indicating a scope of work;
predicting at least one resource required to complete the scope of work, the predicting comprising processing the user data with a machine learning (ML) process;
determining at least one provisioning property of the at least one resource;
applying the at least one provisioning property to a standard product offering, thereby creating a customized product offering commensurate with the scope of work; and
performing processing responsive to a user request using the customized product offering.

10. The system of claim 9, wherein the receiving comprises:
presenting a user interface (UI) comprising a progression of interface elements to the user; and
as the UI progresses through the interface elements, receiving and updating the user data through the UI.

11. The system of claim 10, further comprising repeating the predicting, determining, and applying in response to the updating of the user data.

12. The system of claim 9, wherein the determining comprises:
determining at least one resource code of the at least one resource;
mapping the at least one resource code to at least one application programming interface (API) code;
sending at least one API call including the at least one API code to at least one API; and
receiving, from the at least one API in response to the sending, data indicating the at least one provisioning property.

13. The system of claim 9, wherein the processing further comprises:
determining an estimated product offering from the at least one resource; and
providing information describing the estimated product offering to a user.

14. The system of claim 9, wherein the ML process comprises predicting the at least one resource using a multi-label classifier.

15. The system of claim 9, wherein the processing further comprises training at least one ML model used in the ML process with at least a first training data set indicative of example scopes of work and a second training data set indicative of example resources.

16. The system of claim 9, wherein the at least one provisioning property includes at least one price, and the customized product offering includes a product price incorporating the at least one price.

17. A method comprising:
receiving, by at least one processor, user data indicating a scope of work;
predicting, by the at least one processor, at least one resource required to complete the scope of work, the predicting comprising processing the user data with a machine learning (ML) multi-label classifier trained on at least a first training data set indicative of example scopes of work and a second training data set indicative of example resources;
determining, by the at least one processor, at least one provisioning property of the at least one resource;
applying, by the at least one processor, the at least one provisioning property to a standard product offering, thereby creating a customized product offering commensurate with the scope of work; and
performing, by the at least one processor, processing responsive to a user request using the customized product offering.

18. The method of claim 17, wherein: the receiving comprises:
the receiving comprises presenting a user interface (UI) comprising a progression of interface elements to the user and, as the UI progresses through the interface elements, receiving and updating the user data through the UI; and
the method further comprises repeating the predicting, determining, and applying in response to the updating of the user data.

19. The method of claim 17, wherein the determining comprises:
determining at least one resource code of the at least one resource;
mapping the at least one resource code to at least one application programming interface (API) code;
sending at least one API call including the at least one API code to at least one API; and
receiving, from the at least one API in response to the sending, data indicating the at least one provisioning property.

20. The method of claim 17, further comprising:
determining, by the at least one processor, an estimated product offering from the at least one resource; and
providing, by the at least one processor, information describing the estimated product offering to a user.
